(19) United States
(12) Patent Application Publication
(10) Pub. No.: US 2026/0049634 A1
(43) Pub. Date: Feb. 19, 2026

(54) FLANGED JOURNAL BEARINGS FOR EXTENDED USE

(71) Applicant: Roper Pump Company LLC, Commerce, GA (US)

(72) Inventors: Cody Richard Reynolds, Covington, GA (US); Daniel Todd Hampson, Athens, GA (US); Shane Austin McCullough, Athens, GA (US); Tyson Bentley Anderson, Watkinsville, GA (US)

(21) Appl. No.: 19/279,777

(22) Filed: Jul. 24, 2025

Related U.S. Application Data
(60) Provisional application No. 63/684,513, filed on Aug. 19, 2024.

(51) Int. Cl. F16C 17/02

(52) U.S. Cl. CPC F16C 17/02; F16C 2360/42

(57) ABSTRACT

An endplate, a pump, a bearing, and a method are described herein for simplifying inspection and extending bearing life of journal bearings in positive displacement pumps. An endplate assembly for a positive displacement includes an endplate with an inside surface configured to be secured to a side of the main case, an outside surface, a bore extending through the endplate from the inside surface to the outside surface, and a mating pocket formed around the bore. The endplate assembly also includes a journal bearing that with a sleeve configured to fit within the bore and receive a shaft therein, and a flange configured to fit within the mating pocket. The flange has a perimeter with a shape that prevents rotation of the journal bearing when the flange is seated within the mating pocket.

### CROSS-REFERENCE TO RELATED APPLICATION

This application claims priority to under 35 U.S.C. § 119, based on U.S. Provisional Application No. 63/684,513, filed Aug. 19, 2024, titled “Flanged Journal Bearings for Extended Use,” the disclosure of which is hereby incorporated by reference.

### BACKGROUND

In pumps, such as gear pumps, and many other rotary machines, bearings are used to support the rotor(s) while still allowing the rotor to rotate freely. The two primary bearing technologies used are rolling element bearings and plain journal bearings. Journal bearings have the advantages of being generally less expensive and requiring less maintenance than rolling element bearings. A disadvantage to journal bearings is that, depending on the operating conditions and time elapsed, the bearing material can wear away and lead to failure or loss in efficiency of the machine. Journal bearings are often installed in the pump with an interference fit, so the bearings must be removed with special tooling to allow the bearings to be replaced. In many instances, when pump journal bearings need to be replaced, most of the pump needs to be disassembled to access and remove the journal bearings.

### BRIEF DESCRIPTION OF THE DRAWINGS

FIG. 1 is a side perspective view of a pump according to implementations described herein;

FIG. 2A is an assembly view of a faceplate with journal bearings, according to an implementation;

FIG. 2B is a front perspective view of a faceplate with installed journal bearings according to an implementation;

FIGS. 3A-3D are front perspective, rear perspective, front, and side views, respectively, of a flanged journal bearing, according to an implementation;

FIGS. 4A and 4B are front views of a portion of a faceplate with an installed flanged journal bearing, according to implementations described herein;

FIG. 5 is a rear view of a faceplate with installed flanged journal bearings according to an implementation;

FIG. 6 is an assembly view of a faceplate with installed flanged journal bearings and a cover plate, according to an implementation;

FIG. 7 is a flow diagram of a process for modifying flanged journal bearings in a pump, according to an implementation described herein;

FIGS. 8A and 8B are front perspective and rear perspective views, respectively, of a faceplate assembly with a flanged journal bearing, according to another implementation described herein;

FIG. 9 is an assembly view of the faceplate assembly of FIGS. 8A and 8B;

FIGS. 10A and 10B are front views of a portion of a faceplate with an installed flanged journal bearing according to additional embodiments described herein; and

FIGS. 11A and 11B are front and rear views, respectively, of a flanged journal bearing, according to another implementation described herein.

### DETAILED DESCRIPTION

The following detailed description refers to the accompanying drawings. The same reference numbers in different drawings may identify the same or similar elements. Also, the following detailed description does not limit the invention.

Wear of journal bearings can lead to failure or loss of efficiency in a pump or other rotating machine. The area in the journal bearing that is typically degraded tends to oppose the direction of the load on the rotating shaft. In positive-displacement pumps, for example, the load is generally directed from the discharge side to the inlet side. Pump journal bearings are difficult to remove or replace, often requiring the use of special tools. There remains a need for journal bearings that extend the time between replacement of the bearings and simplify the replacement process. There also remains a need for a positive-displacement pump that can accommodate such bearings.

Systems and methods described herein provide a flanged journal bearing to support rotating shafts within a pump, such as a positive-displacement pump. The flanged journal bearings are configured for a clearance fit (also referred to as a slip fit) with the pump housing (in contrast with a press fit or interference fit, for example), so they can be removed without special tools. The flanged journal bearing is prevented from rotating within the clearance hole of the pump housing while the pump is operating. More particularly, the flanged surface on the journal bearing has a shape (e.g., a geometric shape that provides at provides at least two non-rotating orientations) which sits in a mating pocket in the housing to prevent rotation around an axis of the shaft. The shape of the flange (and corresponding pocket in the housing) may be geometrically similar with one or more surfaces to prevent rotation.

According to an implementation, the flanged journal bearing may be removed and reused in a different orientation. For example, when the journal bearings degrade, the affected material is generally limited to one area of the inner cylindrical surface. In pump bearings, this quadrant typically opposes the discharge side of the pump. Thus, once one quadrant of the bearing is worn past an acceptable limit, the entire journal bearing can be removed from the housing, rotated, and reinstalled so that the shaft will now wear on a new portion of the cylindrical bearing surface. Depending on the shape of the flange, this rotation or reorientation process could be carried out multiple times, extending the total operating life of the flanged journal bearing.

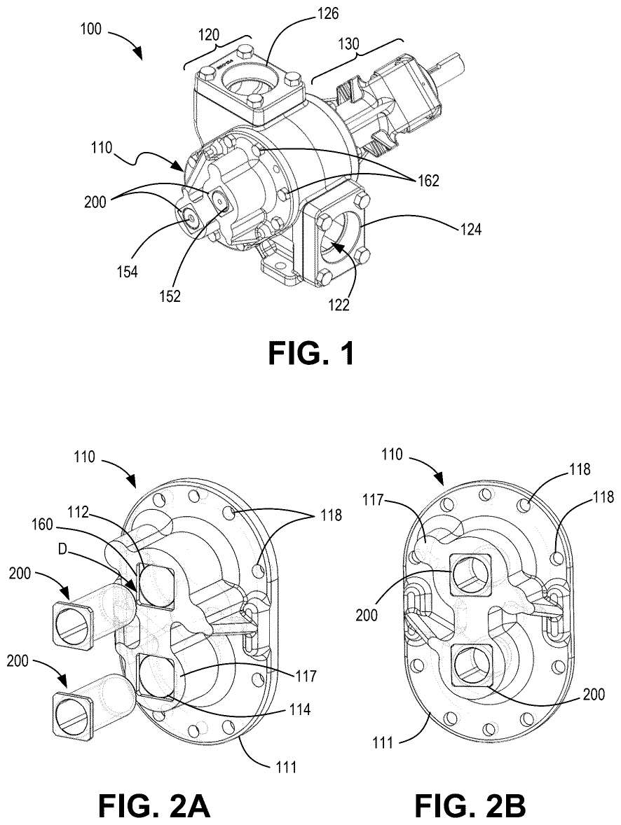

Exemplary embodiments for a gear pump 100 with flanged journal bearings are described with reference to the accompanying figures. FIG. 1 provides a side perspective view of a pump 100, according to implementations described herein. As shown in FIG. 1, pump 100 may include a faceplate assembly 110, a main case 120, and a backplate assembly 130.

Main case 120 may be formed (e.g., cast, machined, etc.) as a single piece or may be formed by joining multiple body sections to form gear chamber 122. Gear chamber 122 may have apertures in fluid communication with an inlet port 124 and an outlet port 126. As shown in FIG. 1, faceplate assembly 110 may be attached to a font surface of main case 120 and backplate assembly 130 may be attached to a rear surface of main case 120 to otherwise enclose gear chamber 122. Faceplate assembly 110 and backplate assembly 130 may be generally referred to as an endplate assembly. Inlet port 124 and outlet port 126 are not limited by their size or shape, and their locations may be generally in perpendicular planes (as shown in FIG. 1) or on opposite sides of gear chamber 122. Spaced apertures in gear chamber 122 register with inlet port 124 and an outlet port 126, with the inlet port 124 being open to an inlet passage of pump 100, and the outlet port 126 being open to an outlet passage of pump 100.

Main casing 120 is configured to include a pair of gears (not shown) journaled in gear chamber 122. One gear may be mounted to rotate with a drive shaft or axle 152 at its center. A driven gear may be similarly mounted for rotation with an idler shaft 154. Drive shaft 152 and idler shaft 154 may be supported on opposite ends by faceplate assembly 110 and backplate assembly 130. Drive shaft 152 and idler shaft 154 may each be made of the same material, such as steel or another rigid material.

The gears may be formed to provide a profile with a radius of curvature nearly equal to the radius of curvature of rounded wall sections within portions of gear chamber 122. During operation, fluid is drawn from inlet port 124 into chamber 122. As the gears rotate, fluid is trapped in cavities between the gear teeth and rounded wall sections of chamber 122. The drawn fluid is swept from inlet port 124 by the intermeshing gears through chamber 122 to outlet port 126 where the fluid is forced out of main case 120.

FIG. 2A is an assembly view of faceplate assembly 110, and FIG. 2B is a front perspective view of faceplate assembly 110 with journal bearings 200 installed according to an implementation. Faceplate assembly 110 may include a faceplate 111 (also generally referred to as an endplate) and flanged journal bearings 200. Flanged journal bearings 200 (also referred to herein as “bearings 200”) may be included within faceplate assembly 110 to support shafts 152/154, allow shaft rotation, and provide a replaceable wear surface. Bearings 200 may be formed from a variety of materials, including bronze, tungsten carbide, etc.

As seen in FIGS. 2A and 2B, faceplate assembly 110 may include a structure to close off one side of main case 120. Bore 112 through faceplate 111 may be configured to receive one flanged journal bearing 200, and bore 114 through faceplate 111 may be configured to receive another flanged journal bearing 200. Bores 112 and 114, along with flanged journal bearings 200, may be configured to support drive shaft 152 and idler shaft 154 while permitting rotation of each shaft 152/154.

As shown in FIG. 1, in one configuration, gear chamber 122 is closed on its front side by faceplate assembly 110 with a fluid-tight seal, as understood by one skilled in the art. For example, faceplate assembly 110 may include a set of bolt holes 118 (FIGS. 2A/2B) near the periphery of faceplate 111 and extending longitudinally (e.g., substantially parallel to bores 112 and 114) through faceplate 111. Main case 120 may include a corresponding set of threaded connection holes extending at least partially into main case 120. Bolts 162, inserted through the bolt holes 118 into the connection holes of main case 120, connect faceplate assembly 110 to main case 120 and align bores 112 and 114 for receiving shafts 152 and 154, respectively. In one implementation, main case 120 and faceplate assembly 110 may be bolted together and sealed using a compressible gasket (not shown) therebetween.

In addition to providing a lubricated and/or reduced-friction surface for shaft rotation, bearings 200 may provide a replaceable wear surface that can be changed out over time to protect shafts 152/154. According to implementations described herein, flanged journal bearing 200 may be provided with a clearance fit for bores 112/114 that allows bearings 200 to be easily inserted into or pulled out of bores 112/114. Bearings 200 may be inserted into one of multiple fixed orientations. In some implementations, faceplate assembly 110 may be configured such that bearings 200 are accessible for inspection and/or reorientation without opening main case 120 and/or while shafts 112/114 are within respective bores 152/154. As described further herein, faceplate assembly 110 may also include a cover plate to secure bearings 200 in some implementations.

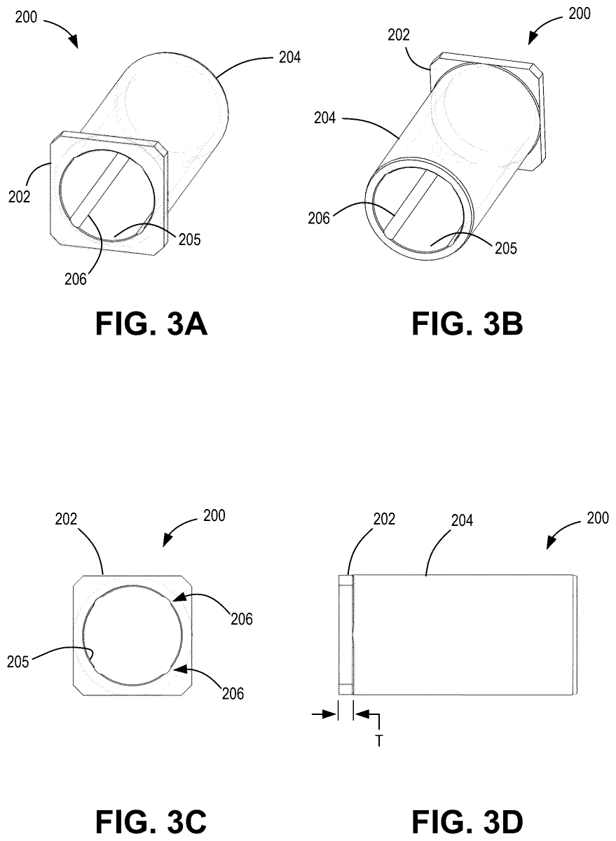

FIGS. 3A-3D are views of flanged bearing 200. Bearing 200 may include a sleeve 204 and a flange 202. Sleeve 204 may include a substantially cylindrical shape. The outer diameter of sleeve 204 is configured to fit within bore 112 or bore 114. According to an implementation, sleeve 204 may be configured with a clearance fit within bores 112/114. For example, in one implementation, there may be a diametral clearance of approximately 0.001 to 0.002 inches (0.254 to 0.508 millimeters) between the outer diameter of sleeve 204 and the inner diameter of bore 112/114 when bearing 200 is installed within bore 112/114. The inner diameter of sleeve 204 is configured to fit over shafts 152 or 154, permitting rotation of shafts 152/154 within sleeve 204.

According to an implementation, bearing 200 may include multiple grooves 206 along the inner surface 205 of sleeve 204. Grooves 206 may generally channel fluid and may serve to improve a hydrodynamic film effect between shafts 152/154 and sleeve 204. For pump bearings, the hydrodynamic film effect effectively creates a cushion of process fluid that increases the life and efficiency of bearings 200. As shown in FIGS. 3A and 3B, grooves 206 may extend parallel to the sleeve axis along the length of sleeve 204. In other implementations, grooves 206 may have a spiral orientation about inner surface 205, have a dimpled (e.g., non-contiguous pattern), or other arrangement.

Flange 202 may extend orthogonally from one end of sleeve 204. In contrast with flanged bearings that are designed for managing thrust loads, the primary purposes of flange 202 in bearing 200 are to prevent free rotation of the sleeve 204 within bores 112/114, to align the orientation of sleeve 204 relative to bores 112/114, and to permit extraction of bearing 200 from bores 122/114. Flange 202 may be configured to set or fit within mating pocket 160 (FIG. 2A) of bore 112/114 such that flange 202 is constrained by the geometry of mating pocket 160 from rotation (e.g., rotation initiated by shafts 152/154 rotating inside of sleeve 204). In one implementation, the perimeter of mating pocket 160 may have at least two sides, so as to prevent axial rotation of flange 202 within mating pocket 160. Mating pocket 160 may be configured to receive flange 202 such that flange 202 is flush with the adjacent exterior surface 117 of faceplate 111 when bearing 200 is fully inserted into bores 112/114. For example, as best shown in FIG. 2A, mating pocket 160 may have a depth, D, that is equal to or slightly greater than a thickness, T (FIG. 3D), of flange 202.

According to an implementation, flange 202 and mating pocket 160 may each have a perimeter that allows flange 202 to fit within a corresponding mating pocket 160 in different fixed orientations. For example, as best shown in in FIGS. 2A-4B, flange 202 may have a square perimeter, circumscribed around the outer circumference of sleeve 204, that allows for insertion of sleeve 204 at four different non-rotating orientations within mating pocket 160. In other implementations, flange 202 may have a rectangular perimeter (e.g., allowing for two different non-rotating orientations within a corresponding mating pocket 160), an isosceles triangle perimeter (e.g., allowing for three different non-rotating orientations within a corresponding mating pocket 160), a regular hexagon perimeter (e.g., allowing for six different non-rotating orientations within a corresponding mating pocket 160), etc.

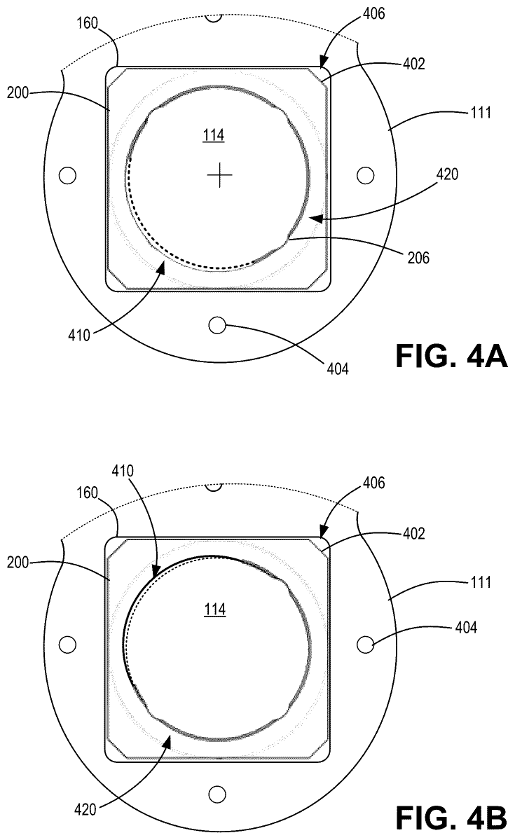

Bearing 200 may be rotated within bores 112/114 to extend the service life of bearing 200. For example, wear on sleeve 204 typically occurs most prominently in a particular area 410 or quadrant of sleeve 204 (e.g., an area opposite the direction of the loads on rotating shafts 152/154). For example, as shown in FIG. 4A, a wear area 410 may form on sleeve 204 after a period of pump 100 service time. In one implementation, grooves 206 may serve as an indicator for wear on sleeve 204. Wear area 410 may be identified, for example, by the loss of material and/or wearing away of a groove 206.

In another implementation, a scribe line may be included on one or more surfaces of bearing 200 as a wear indicator. FIGS. 11A and 11B are front and rear views of bearing 200. For example, as shown in FIG. 11A, a circular scribe line 1102 may be applied on a face of flange 202 around inner surface 205. Additionally, or alternatively, as shown in FIG. 11B, a circular scribe line 1104 may be applied on an exposed surface on the end of sleeve 204 around inner surface 205. Scribe lines 1104/1105 may be formed by etching, inking, or another type of marking. In still another implementation, an end of sleeve 204 may be chamfered to a diameter of the scribe lines 1104 or 1105 to indicate a wear boundary. When the inner surface 205 of sleeve 204 becomes worn to the degree that inner surface 205 reaches a portion of scribe line 1104/1105 or the chamfer edge, then it indicates that maintenance is due. Scribe lines 1104/1105 may be included on bearing 200 with or without grooves 206.

As shown in FIG. 4B, bearing 200 may be removed (or partly removed) from a bore 112/114, rotated (e.g., 90 degrees, 180 degrees, or some other amount), and reinserted over shaft 152/154 so that a more lightly worn area 420 of sleeve 204 is positioned to receive the higher shaft loads. Worn area 410, shown by the solid line in FIG. 4B, is shown rotated in the clockwise direction approximately 90 degrees from its original location.

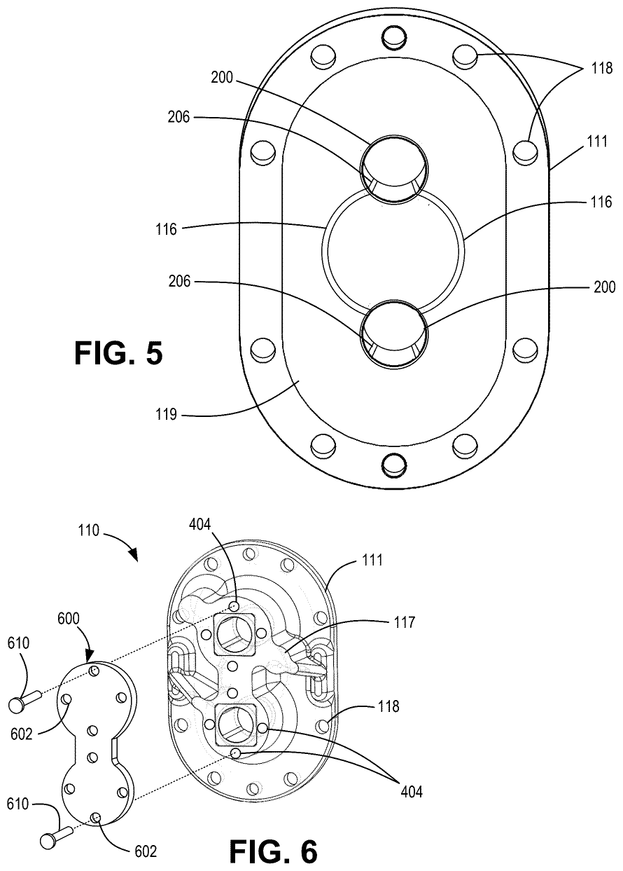

FIG. 5 is a view of the interior surface 119 of faceplate 111 with bearings 200 installed. As shown in FIG. 5, fluid channels 116 may be included along the interior surface 119 of faceplate 111, connecting bores 112 and 114. According to an implementation, grooves 206 of bearings 200 may be configured to align with fluid channels 116. More particularly, the non-flanged end of sleeve 204 may be generally flush with the adjacent interior surface 119 of faceplate 111 when bearing 200 is fully inserted into bores 112/114 such that the end of at least one groove 206 matches up with an end of a fluid channel 116. Mating pocket 160 and bearing 200 may be configured such that grooves 206 align with one or more fluid channel 116 in any installed orientation of bearing 200.

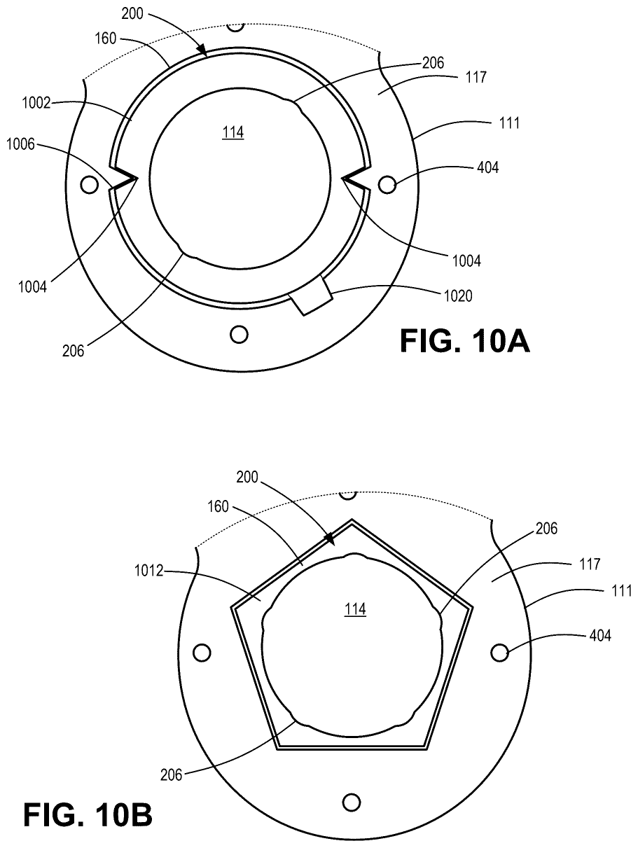

In other implementations, a pry space may be provided between flange 202 and mating pocket 160 to facilitate extraction of bearing 200 from bore 112/114. For example, as illustrated in FIG. 4B, flange 202 may have one or more angled corners 402, relative to the perimeter of mating packet 160. Angled corners 402 may permit insertion of a tool to pull or pry bearing 200 out of bore 112/114. In other implementations, a pry slot (e.g., pry slot 1020, FIG. 10A) may be provided in mating pocket 160 to facilitate removal of bearings 200.

FIG. 6 is an assembly view of faceplate assembly 110 configured with a bearing cover plate 600. In one implementation, cover plate 600 may include a rigid structure that may be formed (e.g., cast, machined, etc.) as a single piece. As shown in FIG. 6, a cover plate 600 may be removably applied or inserted over bearings 200 onto external surface 117 of faceplate 111. Cover plate 600 may include holes 602 that align with threaded holes 404 on faceplate 111. Cover plate 600 may be secured to a portion of faceplate 111 using, for example, threaded fasteners 610 that may be inserted through holes 602 and into threaded holes 404. In one implementation, cover plate 600 and faceplate 111 may be bolted together and sealed using a compressible gasket (not shown) therebetween. In another implementation, a different cover arrangement (e.g., a sliding panel, clamps, etc.) may be used to retain bearings 200 and prevent exposure to outside conditions.

Cover plate 600 may be removed to permit inspection, rotation, and/or removal of bearings 200. More particularly, in one implementation, cover plate 600 may be removed by unscrewing fasteners 610, permitting access to bearings 200 and the exposed ends of shafts 152/154 without removal of faceplate assembly 110 from main case 120. Furthermore, bearings 200 may be rotated (e.g., as described above) or replaced without having to access chamber 122 or remove shafts 152/154 from their respective bores 112/114.

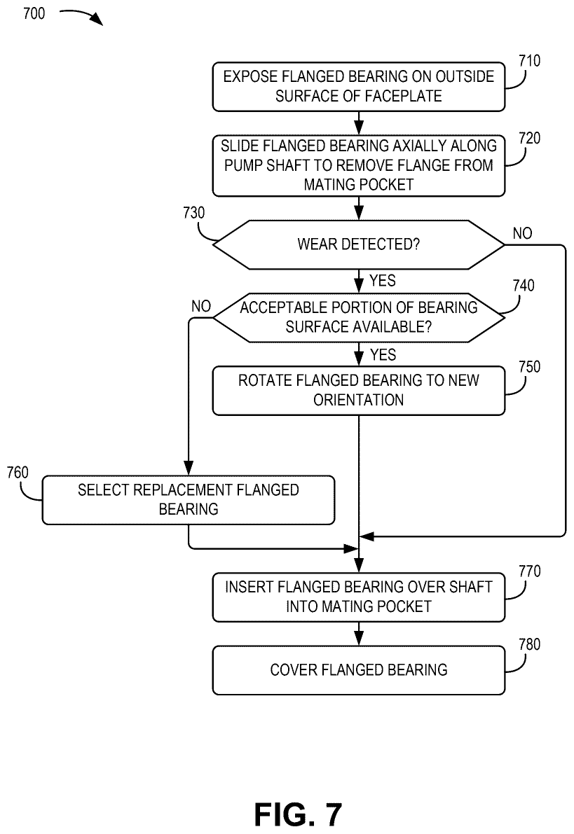

FIG. 7 is a flow diagram of a process 700 for modifying flanged journal bearings in a pump, according to an implementation described herein. Process 700 may include exposing a flanged bearing on an outside surface of a faceplate (block 710) and sliding the flanged bearing axially along a shaft to remove the flange from a mating pocket (block 720). For example, a technician may remove fasteners 610 from cover plate 600 and remove cover plate 600 from faceplate assembly 110 of pump 100. Removing cover plate 600 may expose bearings 200, installed in mating pockets 160 and within bores 112/114 over the ends of shafts 152/154. The technician may partially or completely pull out (e.g., axially move) a bearing 200 from the respective shaft 152/154 (e.g., at least as far out so that flange 202 is not constrained from rotation by mating pocket 160).

Process 700 may further include determining if there is an area of wear on the bearing (block 730). For example, a technician may inspect bearing 200 for signs of wear, such as wear of a groove 206 in area 410, as described above in connection with FIG. 4A.

If an area of wear is detected (block 730—Yes), process 700 may include determining if there is an acceptable portion of bearing surface available (block 740). For example, a technician may inspect bearing 200 for areas of sleeve 204 that do not have significant wear, such as area 420, as described above in connection with FIG. 4B.

If there is an acceptable portion of bearing surface not having significant wear on the bearing (block 740—Yes), process 700 may include rotating the flanged bearing on the shaft to a different orientation relative to the mating pocket (block 750). For example, bearing 200 may be rotated so that a less worn area or low-wear area (e.g., area 420) is aligned in the previously worn location (e.g., at the prominent load area of shaft 152/154).

If there is not an acceptable portion of bearing surface not having significant wear on the bearing (block 740-No), process 700 may include obtaining a replacement flanged bearing (block 760). For example, a technician may select a new flanged bearing 200 to insert over shaft 112/114 in place of the worn bearing 200.

After rotating the flanged bearing, obtaining a replacement bearing, or if there is no wear detected (block 730-No), process 700 may include inserting the flange bearing over the shaft and into the mating pocket (block 770) and covering the flanged bearing (block 780). For example, a bearing with acceptable wear levels at the high load area (e.g., an unworn bearing 200, a rotated bearing 200, or new bearing 200) may be inserted (or axially moved) over shaft 152/154 with flange 202 positioned in mating pocket 160. Cover plate 600 (or another type of cover) may be secured to faceplate 111 using threaded fasteners 610, for example.

Use of flanged bearings, accessible from an outside surface of a faceplate for gear pump as described above, may simplify bearing inspections and provide for longer service life for the bearings by allowing rotation of worn bearing surfaces away from prominent load points.

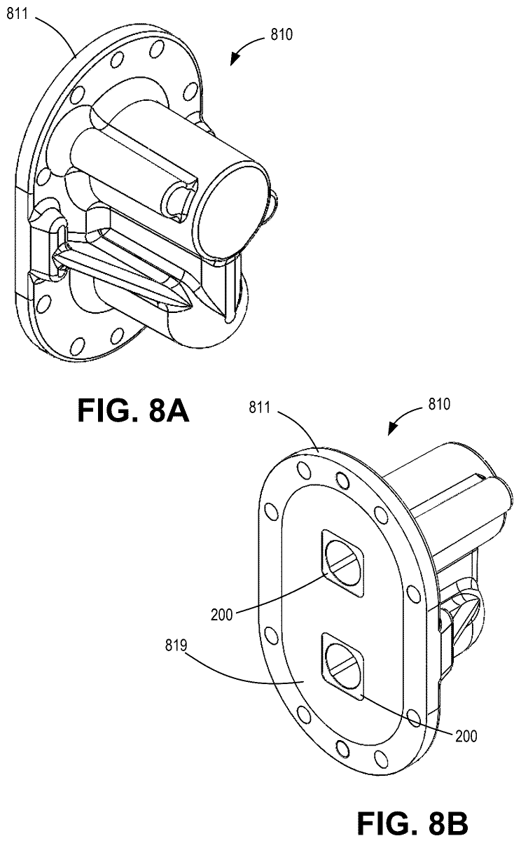

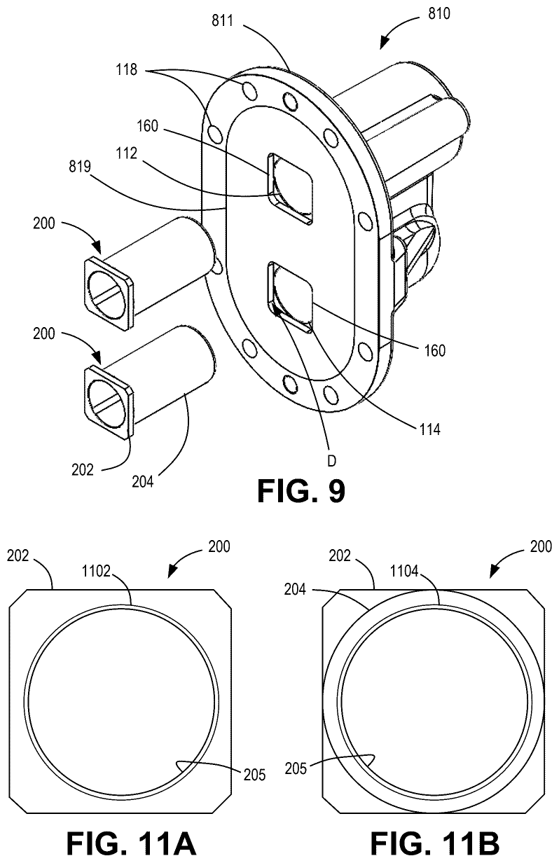

FIGS. 8A and 8B are front and rear perspective views of a faceplate assembly 810 with flanged journal bearings 200, according to another implementation. FIG. 9 is an assembly view of faceplate assembly 810. Faceplate assembly 810 may include faceplate 811 and bearings 200.

Similar to faceplate 111 described above, faceplate 811 may include bores 112/114 and bolt holes 118. Faceplate 811 may be connected to a main case 120 and align bores 112 and 114 for receiving shafts 152 and 154, respectively. In some implementations, faceplate 811 may also be configured with fluid channels 116 (not shown).

Referring collectively to FIGS. 8A-9, faceplate 811 may include mating pockets 160 formed into an interior surface 819 of faceplate 811. Mating pocket 160 may be configured to receive flanged journal bearings 200. More particularly, mating pocket 160 may be configured to receive flange 202 such that flange 202 is flush with the adjacent interior surface 819 of faceplate 811 when bearing 200 is fully inserted into bores 112/114. For example, as best shown in FIG. 9, mating pocket 160 may have a depth, D, that is equal to or slightly greater than a longitudinal thickness, T (FIG. 3D), of flange 202.

Similar to the arrangements shown in FIGS. 1-6, in the configuration of FIGS. 8A-9, bearing 200 may be inserted in mating pockets 160 to prevent free rotation of the sleeve 204 within bores 112/114, to align the orientation of sleeve 204 relative to bores 112/114, and to permit extraction of bearing 200 from bores 122/114. Sleeve 204 may be configured for a clearance fit within bores 112/114 to allow for removal, inspection, and rotation of bearing 200 without requiring special tools, such as are typically needed to remove press fit bearings.

According to an implementation, faceplate 811 may be a retrofit component, such as a conventional faceplate that is modified to add mating pockets 160. In the configuration of FIGS. 8A-9, bearing 200 may be accessed by removing faceplate assembly 810 from main case 120. Accordingly, no cover plate 600 is necessary for faceplate assembly 810.

FIG. 10A is a front view of a portion of faceplate 111 with another embodiment of flanged journal bearing 200, according to another implementation. As shown in FIG. 10A, a flange 1002 may have a substantially round perimeter, around the outer circumference of sleeve 204 (not visible in FIG. 10A), with cutouts 1004 arranged at opposite sides of flange 1002. Mating pocket 160 may include a substantially circular profile with corresponding protrusions 1006 for cutouts 1004. The configuration of FIG. 10A allows for insertion of bearing 200 at two different orientations within mating pocket 160, such that a worn bearing area may be rotated away from a prominent load area caused by pump shaft 152/154.

As further shown in FIG. 10A, a pry slot 1020 may be included adjacent to mating pocket 160. Pry slot 1020 may, for example, extend beyond the perimeter of mating pocket 160, and have a slightly greater depth than mating pocket 160, to allow for a tool be slid under a portion of flange 1002 for removal of bearing 200.

FIG. 10B is a front view of a portion of faceplate 111 with still another embodiment of flanged journal bearing 200, according to another implementation. As shown in FIG. 10B, a flange 1012 may have a regular pentagon-shaped perimeter, circumscribed around the outer circumference of sleeve 204 (not visible in FIG. 10B). The configuration of FIG. 10B allows for insertion of bearing 200 at five different orientations (e.g., each of the five sides being located at the typical wear area) within mating pocket 160, such that a worn bearing area may be rotated away from a prominent load area caused by shaft 152/154.

Although FIGS. 10A and 10B show alternate flange/groove arrangements for bearing 200, in other implementations, different flange/groove arrangements may be used. For example, in other implementations, a flange for three fixed orientations or six or more fixed orientations may be provided. Furthermore, while one groove 206 is shown for each fixed orientation in FIGS. 10A and 10B, in other implementations, bearing 200 may include more or fewer grooves (including no grooves) than the number of fixed orientations. Also, the alternate flange/groove arrangements of FIGS. 10A and 10B may also be used on inner surfaces 119 or 819 in a manner similar to those described above.

An endplate assembly, a pump, a bearing, and a method are described herein for simplifying inspection and extending bearing life of journal bearings in, for example, positive displacement pumps. According to one implementation, an endplate assembly for a positive displacement pump is provided. The endplate assembly includes an endplate with an inside surface configured to be secured to a side of the main case, an outside surface, a bore extending through the endplate from the inside surface to outside surface, and a mating pocket formed on the outside surface around the bore. The endplate assembly also includes a journal bearing that includes a sleeve configured to fit within the bore and receive a shaft therein, and a flange configured to fit within the mating pocket. The flange has a perimeter with a shape that prevents rotation of the journal bearing when the flange is seated within the mating pocket.

According to another implementation, a pump includes a main case having a chamber including a suction or inlet port and a discharge or outlet port and a faceplate. The faceplate may include an inside surface secured to a side of the main case, an outside surface, a bore extending from the inside surface to outside surface, and a mating pocket formed on the outside surface around the bore. The pump further includes a shaft configured to extend through the chamber into the bore of the faceplate and a journal bearing including a sleeve and a flange. The sleeve may be configured to fit within the bore and around the shaft, and the flange may be configured to fit within the mating pocket. The flange has a perimeter with a shape that prevents rotation of the journal bearing when the flange is seated within the mating pocket.

According to still another implementation, a journal bearing includes a sleeve configured to fit within a bore of a faceplate and receive a shaft therein and a flange configured to fit within a mating pocket of the faceplate. The flange has a perimeter with a geometric shape that prevents rotation of the journal bearing when the flange is seated within the mating pocket. The flange may be configured to sit within the mating pocket in at least two non-rotating orientations. The journal bearing further includes multiple grooves formed along an inside surface of the sleeve. Each of the at least two non-rotating orientations may align one of the multiple grooves with a fluid channel provided on the faceplate.

In a further implementation, a method for modifying a flanged bearing in a pump is provided. The method includes exposing the flanged bearing on an outside surface of a faceplate, The flanged bearing may include a sleeve mounted within a bore over a pump shaft and a flange seated in a first fixed orientation within a mating pocket on the outside surface. The method also includes sliding the flanged bearing axially along the pump shaft to remove the flange from the mating pocket, rotating the flanged bearing to align with a second fixed orientation relative to the mating pocket, and sliding the rotated flanged bearing axially along the pump shaft to insert the flange into the mating pocket. The method may also include covering the flanged bearing.

The foregoing description of exemplary implementations provides illustration and description but is not intended to be exhaustive or to limit the embodiments described herein to the precise form disclosed. Modifications and variations are possible in light of the above teachings or may be acquired from practice of the embodiments. For example, while series of blocks have been described with regard to the processes illustrated in FIG. 7, the order of the blocks may be modified according to other embodiments. Further, non-dependent blocks may be performed in parallel. Additionally, other processes described in this description may be modified and/or non-dependent operations may be performed in parallel.

Although the invention has been described in detail above, it is expressly understood that it will be apparent to persons skilled in the relevant art that the invention may be modified without departing from the spirit of the invention. Various changes of form, design, or arrangement may be made to the invention without departing from the spirit and scope of the invention. Therefore, the above-mentioned description is to be considered exemplary, rather than limiting, and the true scope of the invention is that defined in the following claims.

As set forth in this description and illustrated by the drawings, reference is made to “an exemplary embodiment,” “an embodiment,” “embodiments,” etc., which may include a particular feature, structure or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The terms “a,” “an,” and “the” are intended to be interpreted to include one or more items. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such.

What is claimed is:

1. A pump, comprising:
a main case having a chamber including an inlet port and an outlet port;
a faceplate including:
an inside surface secured to a side of the main case,
an outside surface,
a bore extending from the inside surface to the outside surface, and
a mating pocket formed on the outside surface around the bore;
a shaft configured to extend through the chamber into the bore of the faceplate; and
a journal bearing including a sleeve and a flange,
wherein the sleeve is configured to fit within the bore and around the shaft,
wherein the flange is configured to fit within the mating pocket, and
wherein the flange has a perimeter with a shape that prevents rotation of the journal bearing when the flange is seated within the mating pocket.

2. The pump of claim 1, wherein the journal bearing has a clearance fit between the bore and the sleeve.

3. The pump of claim 1, further comprising:
a cover plate secured to the outside surface of the faceplate over the journal bearing.

4. The pump of claim 1, wherein the flange is configured to fit within the mating pocket in at least two non-rotating orientations.

5. The pump of claim 4, wherein the inside surface includes a fluid channel,
wherein the sleeve comprises multiple grooves along an inside surface of the sleeve, and
wherein each of the at least two non-rotating orientations align one of the multiple grooves with the fluid channel.

6. The pump of claim 1, wherein the flange is configured to fit within the mating pocket in four different non-rotating orientations.

7. The pump of claim 1, wherein a depth of the mating pocket is greater than or equal to a longitudinal thickness of the flange.

8. The pump of claim 1, further comprising a cover plate for the journal bearing, wherein the cover plate is removable to access the journal bearing while the shaft is within the bore.

9. An endplate assembly for a positive displacement pump, the endplate assembly comprising:
an endplate including:
an inside surface configured to be secured to a side of the main case,
an outside surface,
a bore extending from the inside surface to the outside surface, and
a mating pocket formed around the bore; and
a journal bearing comprising:
a sleeve configured to fit within the bore and receive a shaft therein, and
a flange configured to fit within the mating pocket, wherein the flange has a perimeter with a shape that prevents rotation of the journal bearing when the flange is seated within the mating pocket.

10. The endplate assembly of claim 9, wherein the journal bearing has a clearance fit between the bore and the sleeve.

11. The endplate assembly of claim 9, further comprising:
a cover plate configured to be secured to the outside surface of the endplate over the journal bearing.

12. The endplate assembly of claim 9, wherein the flange is configured to fit within the mating pocket in at least two non-rotating orientations.

13. The endplate assembly of claim 12, wherein the inside surface includes a fluid channel,
wherein the sleeve comprises multiple grooves along an inside surface of the sleeve, and
wherein each of the at least two non-rotating orientations align one of the multiple grooves with the fluid channel.

14. The endplate assembly of claim 9, wherein a depth of the mating pocket is greater than or equal to a thickness of the flange.

15. The endplate assembly of claim 9, further comprising a pry space between the mating pocket and the flange.

16. The endplate assembly of claim 9, wherein the mating pocket is formed on the inside surface around the bore.

17. A method for modifying a flanged bearing in a pump, the method comprising:
exposing the flanged bearing on an outside surface of a faceplate, wherein the flanged bearing includes a sleeve mounted within a bore over a pump shaft and a flange seated in a first fixed orientation within a mating pocket on the outside surface;
moving the flanged bearing axially along the pump shaft to remove the flange from the mating pocket;
rotating the flanged bearing to a second fixed orientation relative to the mating pocket;
moving the rotated flanged bearing axially along the pump shaft to insert the flange into the mating pocket; and
covering the flanged bearing.

18. The method of claim 17, wherein exposing the flanged bearing comprises:
removing a cover plate that is attached to the faceplate, while retaining the sleeve over the pump shaft.

19. The method of claim 17, wherein rotating the flanged bearing to a second fixed orientation further comprises:
detecting a low-wear area on the sleeve, wherein the second fixed orientation aligns the low-wear area with a prominent load area from the pump shaft.

20. A journal bearing, comprising:
a sleeve configured to fit within a bore of a faceplate and receive a shaft therein;
a flange configured to fit within a mating pocket of the faceplate,
wherein the flange has a perimeter with a geometric shape that prevents rotation of the journal bearing when the flange is seated within the mating pocket,
wherein the flange is configured to sit within the mating pocket in at least two non-rotating orientations; and
multiple grooves formed along an inside surface of the sleeve,
wherein each of the at least two non-rotating orientations align one of the multiple grooves with a fluid channel provided on the faceplate.
